(19) United States
(12) Patent Application Publication
(10) Pub. No.: US 2002/0149491 A1
(43) Pub. Date: Oct. 17, 2002

(54) EGRESS SYSTEM

(76) Inventors: William F. Crandall JR., Sausalito, CA (US); Linda L. Myers, Mill Valley, CA (US)

Correspondence Address: SIEBERTH & PATTY, 2924 BRAKLEY DRIVE SUITE A 1, BATON ROUGE, LA, 70816

(21) Appl. No.: 09/811,324

(22) Filed: Mar. 16, 2001

Related U.S. Application Data
(60) Provisional application No. 60/260,998, filed on Jan. 11, 2001.

(51) Int. Cl. G08B 3/00

(52) U.S. Cl. 340/691.1; 340/691.6; 340/692; 340/541; 340/531

(57) ABSTRACT

An egress system for use in a structure which defines a plurality of paths of travel where the system comprises one or more visual signs, each visual sign being located at a selected point along one or more paths of travel and each visual sign being configured to convey information in the form of visual communication and to convey at least two alternative messages. The system further comprises a central processing unit and one or more sensors being configured to detect an environmental condition and to send a signal indicative of this condition to the central processing unit. The central processing unit is configured to determine the safest of the paths of travel based upon signals received from the sensors and to send a processed signal to each of the visual signs to thereby cause the visual signs to convey a pre-selected one of at least two alternative messages, thereby visually identifying at least one of the safest paths of travel under the condition(s) detected. Preferably, the system further comprises audible communication devices which convey messages consistent with identification of the safest paths of travel.

### REFERENCE TO RELATED APPLICATION

This application claims the benefit of U.S. Provisional Patent Application No. 60/260,998, entitled EGRESS SYSTEM, filed on Jan. 11, 2001.

### TECHNICAL FIELD

This invention relates to egress systems which aid both sighted people and blind people, and more particularly to egress systems wherein real-time, situation specific information is given both visually and non-visually from the same system.

### BACKGROUND

Efforts are being made to make public areas safer and more functional for blind people. Despite such attempts, navigating unfamiliar areas in emergency situations still remains a challenge. Braille, raised print and raised line tactile maps have been used to provide directional and emergency information, but these tactile solutions require extensive education, in the case of Braille, and extensive training, in the case of raised print and raised line maps. In addition, they must first be located before they can be read and cannot give real-time information that may be critical in an emergency situation. Pushbutton “speak-out” boxes are an improvement over Braille and raised print because they do not require training, but the boxes must still be located by users and an often complex list of instructions must be memorized in order to successfully travel from the “speak-out” box to the exit. This strategy is useful only because being physically in front of the device provides the user a precise starting point from which to reference subsequent travel directions.

In recent years, an information and wayfinding system has been developed for assisting blind people, which requires minimal training and does not require blind people to locate an audio pushbutton or tactile signs in some central location. The system, marketed under the trademark Talking Signs®, comprises infrared transmitters and receivers which convey directions or other information. The system has been further modified to function in the presence and in the absence of an ambient background of light energy. Because of the directional nature of light, infrared transmissions can be precisely controlled and therefore are highly suitable for wayfinding applications in both indoor and outdoor applications.

Emergency egress without real-time situation-specific information is dangerous for both sighted people and blind people. Exit signs denote possible exits, but lack the real-time information which ensures that a particular exit is safe. Fire, smoke, or a structural collapse could be blocking the exit, but the exit sign would not reflect such hazards. By attempting to exit though a blocked exit or exit route, people may lose critical time and face significant danger.

Some modem fire systems have attempted to provide real-time information differentially to certain areas of a building through public address speakers. However, these systems still require blind people to find a central location from which the announcements will guide them. Also, the announced instructions may be unclear to both sighted people and blind people if several exits are located in the same general area. Therefore, a need exists for a real-time directional system which simultaneously delivers both visual and repeating non-visual information at any given location in a facility. Unlike pushbutton “speak-out” boxes, the acoustic sources of public address systems lack any reference starting point. Therefore, these systems are incapable of providing the turning direction information in a specific enough way to direct blind people through the travel path to the exit. That is, the instruction “turn left” heard by a person traveling in one direction is inappropriate for a person hearing the same message while traveling in the opposite direction.

### SUMMARY OF THE INVENTION

This invention is deemed to fulfill these important needs by providing, among other things, an egress system which is capable of safely and efficiently guiding both sighted people and blind people out of a building or other structure during emergency and non-emergency situations. More particularly, this invention provides an egress system for use in a structure which defines a plurality of possible paths of travel. As used herein, the term “sign” means a visual sign and hereinafter will be referred to as “visual sign.” The system comprises:

a. one or more visual signs, each of the visual signs being located at a selected point along one or more paths of travel, each of the visual signs being configured to convey information in the form of visual communication and to convey at least two alternative messages;

b. a central processing unit; and

c. one or more sensors, each sensor being configured to detect an environmental condition and to send a signal indicative of the condition to the processing unit,

wherein the processing unit is configured to determine the safest of the paths of travel based upon signals received from the sensors, and to send a processed signal to each of the visual signs to thereby cause the visual signs to convey a pre-selected one of at least two alternative messages, thereby visually identifying at least one of the safest of the paths of travel under the condition(s) detected.

For purposes of this text and accompanying figures, the central processing unit, which may be a computer or computing system, may be alternately referred to as a central processor unit.

In a preferred embodiment, the system further comprises one or more lightwave transmitters, each of the one or more lightwave transmitters being embedded within or proximate to one of the visual signs respectively. Each of the one or more lightwave transmitters is configured to emit a lightwave signal, the lightwave signal being convertible by a receiver into a signal conveying information which is consistent with the information conveyed through visual communication by one of the visual signs. The lightwave signal may be a frequency modulated lightwave signal and is preferably a frequency modulated infrared signal. In one embodiment the lightwave transmitter uses one or more light emitters to send a lightwave signal in the form of one or more encoded speech messages. For example, such encoded speech messages may take the form of analog, pre-recorded human speech messages or analog, synthesized human speech messages. In another embodiment in which the encoded speech message is encoded within the receiver, the lightwave signal sent by the lightwave transmitter is in the form of a code which triggers the receiver to itself emit a preselected audible speech message, appropriate under the circumstances, which message is correlated to the lightwave signal code received. The lightwave transmitter may receive its signal, which will be converted into a lightwave signal code, from the central processing unit or it may receive a signal from another source such as a real-time intercom system or primary microphone (the microphone being located at, for example, a fire control panel). Additionally, the lightwave transmitter may transmit a signal code or audible speech message which is preprogrammed into its own memory system.

Preferably, the system further comprises at least one loudspeaker embedded within or proximate to one of the visual signs respectively. The loudspeaker delivers a loudspeaker soundwave signal. The soundwave signal conveys information in the form of audible communication which is consistent with the information conveyed through visual communication by the loudspeaker's respective visual sign. The loudspeaker may receive its signal, which will be converted into audible communication, from the central processing unit or it may receive a signal from another source such as a transmitter, real-time intercom system or primary microphone (the microphone being located at, for example, a fire control panel). The loudspeaker may also broadcast audible messages that have been pre-programmed into its own memory system.

As used in this description, the term “real-time” means that the substantive information being transmitted by the egress system may change from moment to moment as a function of the programmed output of the central processing unit, which in turn may change from moment to moment as a function of the input from the environmental sensors, this rate of input being a function of the rate at which the sensors may be polled.

It is also preferred that the egress system further comprises the receiver, wherein the receiver is configured to selectively receive the lightwave signal and convert the lightwave signal into intelligible non-visual communication, the receiver being effective only when placed within the range of the lightwave signal. The intelligible non-visual communication may emanate from an audio or an earphone speaker system. In one embodiment the intelligible non-visual communication may be activated by a switch on the receiver. The receiver may tie portable with a self-contained source of electrical energy.

In another preferred embodiment, the visual sign, lightwave transmitter, loudspeaker, sensor, central processing unit, and receiver are component part; of a larger system containing a plurality of visual signs which provide real-time information in the form of visual communication and a lightwave transmitter associated with each visual sign, where at least one of the visual signs is configured to display a message which is consistent with a repeating lightwave signal sent by the lightwave transmitter. The associated loudspeaker is preferably placed at the location of final destination and configured to identify the destination as such. In a particularly preferred embodiment, the final destination location is an exit.

In another particularly preferred embodiment, the system provides an emergency egress system further comprising the conveyance of real-time visual and non-visual communication concerning the location of the nearest safe exit, direction to a safe exit, and/or areas to avoid. The sensor in this particularly preferred embodiment detects a condition which may include, for example, that of the type involving measurements of temperature, smoke, fire, an activated alarm, obstructions, motion, humidity, temperature rate of rise or a combination of any two or more of the foregoing. After receiving information regarding these conditions from the sensor, the central processing unit in this embodiment is then programmed to conduct a risk assessment to determine the safest route(s) of egress and transmit this determination to appropriate display devices.

The egress system may further embody one or more visual signs which is configured to convey the alternative visual message, EXIT, at the end of the safest path of travel. The loudspeaker embedded in or proximate to the visual sign may be configured to repeatedly deliver its soundwave signal.

The egress system may comprise a plurality of visual signs and sensors. The sensors may be capable of detecting a condition which may be selected from the group consisting of temperature, smoke, fire, an activated alarm, obstructions, motion, humidity, temperature rate of rise or a combination of any two or more of the foregoing. These sensors may detect or attempt to detect a condition periodically or continuously. An absence of a condition may also be processed by the central processing unit in its assessment of the safest possible exit route.

Another embodiment of the present invention is a method of providing a safe exit from a structure having a plurality of possible paths of travel comprising employing one or more sensors to detect an environmental condition and sending an electronic signal to a central processing unit. Another step in the method is employing the central processing unit to receive the electronic signal from one or more sensors, determine the safest path of travel for exiting the structure, and transmit the processed electronic signal to one or more communication devices. Such communication devices may include, e.g., visual signs, auditory speakers, loudspeakers, video screens, liquid crystal displays (LCD's), visible light-emitting diodes (LED's), plasma displays, auditory receivers, and digital video devices. A further step in the method is configuring one or more of the communication devices to receive the processed signal and convert the processed signal into either visual communication, intelligible non-visual communication, or both. Such intelligible non-visual communication may include, for example, audible communication or dynamic tactile communication such as, e.g., refreshable Braille.

The egress system of this invention can lend itself to providing a network of sensors, central processing units, and visual and non-visual signs which would be capable of communicating with each other using a protocol of a local-area network or a wide-area network, such as, i.e., the Internet.

These and other embodiments and features of the invention will become still further apparent from the ensuing drawings, description and appended claims.

### BRIEF DESCRIPTION OF THE DRAWINGS

FIG. 1 is a schematic block diagram illustrating a preferred embodiment of this invention.

FIG. 2 is a schematic block diagram illustrating another preferred embodiment of this invention.

FIG. 3 is a schematic block diagram illustrating another preferred embodiment of this invention.

In each of the above figures, like numerals are used to refer to like or functionally like parts among the several figures.

### DETAILED DESCRIPTION OF THE INVENTION

As used herein when describing this invention, the system is not limited to an egress or an emergency egress system, but can instead or in addition, function as a general guidance or directional system.

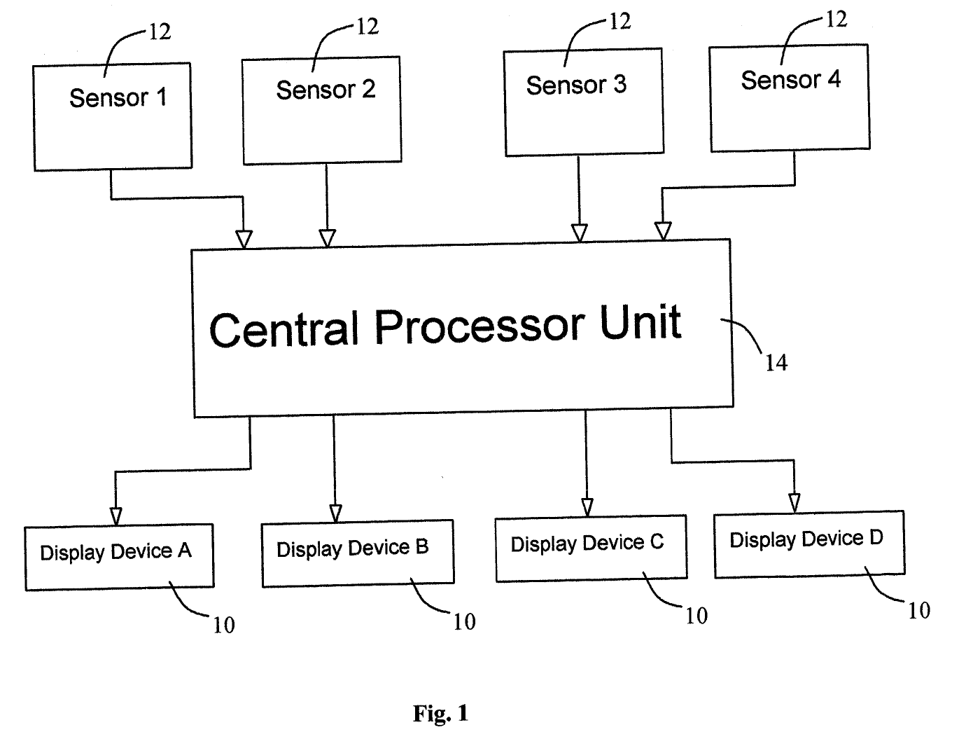

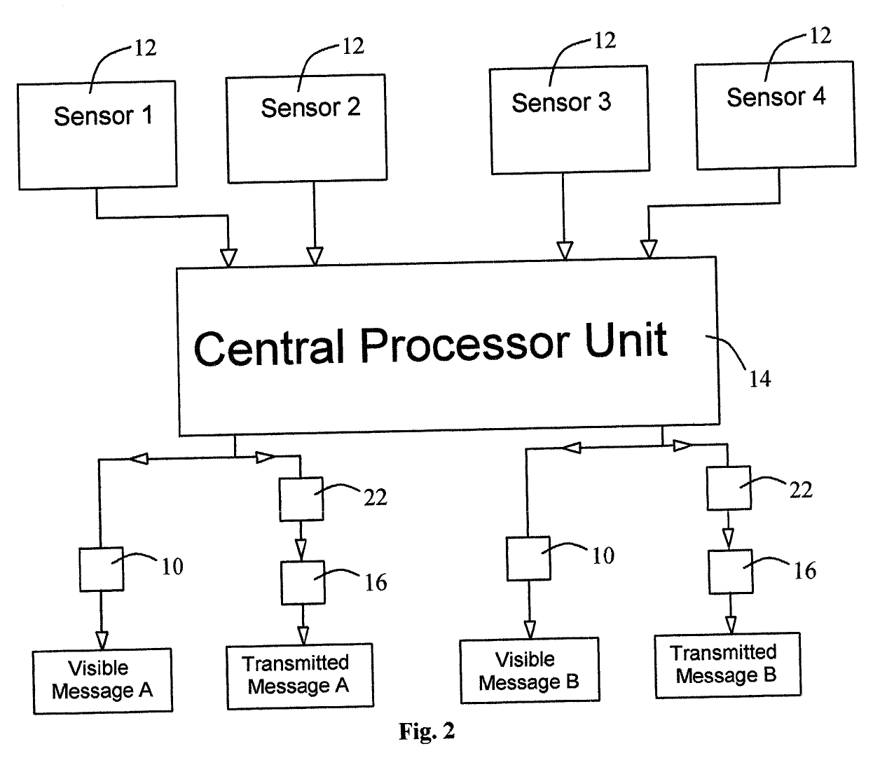

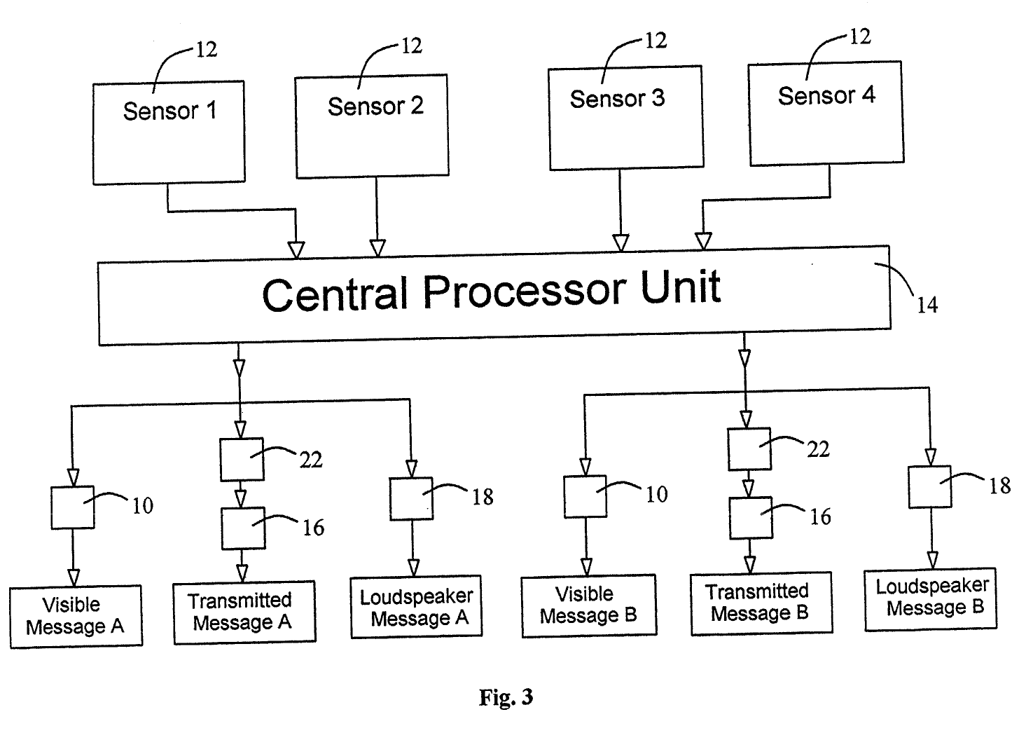

Referring now to the drawings, three alternative embodiments of this invention are depicted in FIGS. 1, 2 and 3. The features of the embodiment of FIG. 1 are included in the embodiment of FIG. 2, while the features of the embodiment of FIG. 2 are included in the embodiment of FIG. 3. Since the embodiment of FIG. 3 includes all of these features, the following discussion will be made with reference to FIG. 3, part of an egress system is illustrated which comprises a plurality of visual signs 10 and lightwave transmitters 22 electronically connected to a central processing unit or central processor unit 14 which receives data from a plurality of sensors 12 and sends the data to the visual signs 10 and lightwave transmitters 22. Visual signs 10 then convey the information in the form of visual communication, and lightwave transmitters 22 convey the information to one or more receivers 16, which convert the information into intelligible non-visual communication (depicted as Transmitted Message A or B in the Figures). Visual signs 10 can be any tangible device for providing a visual display such as, e.g., a static graphical sign, a video screen, a computer monitor, an LCD screen, visible LED's, plasma displays, a digital video device or the like. In the embodiment depicted, the transmitted information from central processing unit 14 is conveyed as well to loudspeakers 18.

Visual signs 10 may be mounted on a wall, hung from a ceiling, or attached to or embedded in the structure in any other manner which allows visual information to be conveyed. Visual signs 10 may be positioned at or near a location from which information is to be conveyed. For example, visual signs 10 may be positioned at or near an exit or a pathway leading to an exit, a stairwell or a lobby, or a motel or hotel room. Preferably, the visual signs 10 are EXIT signs. In emergency situations, EXIT signs are ideal because they are usually positioned at standard emergency route locations, as defined by state law (i.e., at choice points, within 100 feet of each other, and at the final exit doors). For purposes of insuring directional placement of lightwave transmitters 22, they may be placed proximate to or embedded in one or more visual signs 10. Therefore, incorporating lightwave transmitters 22 into EXIT signs can be accomplished as an original equipment manufacturer product.

For sighted persons, the visual information conveyed by visual signs 10 provides directions, guidance, or information concerning environmental conditions relevant to navigating the building or area. For example, visual signs 10 could convey information concerning the location of the nearest safe exit, directions to a safe exit, and/or areas to avoid. The visual information could be displayed in a variety of ways. For example, each visual sign 10 could display a green-lettered EXIT to denote an exit or a route to an exit and, when appropriate under the circumstances, could alternatively display the word, EXIT, with a flashing red diagonal bar to direct users away from that particular exit or exit route. Visual signs 10 could also display illuminated “right turn,” “left turn,” and “straight” arrows to guide users to a viable exit or passageway. Visual signs 10 may also convey repeating messages denoting the final destination, such as a final exit.

The lightwave transmitters 22 of this invention may be any device(s) capable of receiving information sent from central processing unit 14 and sending that information to receiver 16. For example, lightwave transmitter 22 preferably may use light-emitting diodes to send infrared signals in the form of encoded speech messages. Receiver 16 of this invention may be any device capable of sensing a signal and converting that signal into intelligible non-visual communication, which emanates from an audio or earphone speaker. Receiver 16 may be portable or mounted. Preferably, receiver 16 is portable and comprises a self-contained source of electrical energy, such as small electrical batteries. Receiver 16 may be activated by a switch, such as pressing one or more buttons, and may default to an “off” position. The non-visual information emanating from the speaker of receiver 16 is consistent with the information conveyed by visual sign 10 at which receiver 16 will preferably be directed. The information is necessary to guide or inform a visually handicapped user who cannot read the visual information conveyed by visual sign 10. For example, the non-visual information may inform the user “For exit, turn right at the next hall” or “Hazardous route! Follow exit signs in the opposite direction” or “Exit further down this hallway” or “Entrance to exit stairwell.” It is particularly preferred that receiver 16 and lightwave transmitter 22 are constructed and function in accordance with those taught in U.S. Pat. No. 5,986,786, the disclosure of which is hereby incorporated by reference.

Alternatively, receiver 16 may convey a message that has been embedded in its own memory system. In another embodiment in which the encoded speech message is encoded within receiver 16, the lightwave signal sent by lightwave transmitter 22 is in the form of a code which triggers receiver 16 to itself emit a preselected audible speech message, appropriate under the circumstances, which message is correlated to the lightwave signal code received.

Sensors 12 of this invention may be any device capable of detecting an environmental condition which may include, for example, that of the type involving measurements of temperature, smoke, fire, an activated alarm, obstructions, motion, humidity, temperature rate of rise or a combination of any two or more of the foregoing. Sensors 12 are connected by way of a wired or wireless network to a central processing unit 14 or central computing system.

The central processing unit 14, which can also be a computer system in this invention, is any centralized or decentralized system capable of receiving information from sensors 12, processing the signal and sending it to lightwave transmitter 22, loudspeaker 18 and visual sign 10. It will be appreciated by those of skill in the art that central processing unit 14, as the term is used herein, may further comprise some means of communicating processed signals to lightwave transmitters 22, loudspeakers 18 and visual signs 10. Each signal from sensors 12 may be in the form of a continuous or periodic electronic signal indicative of an environmental condition such as, e.g., temperature, smoke, fire, an activated alarm, obstructions, motion, humidity, temperature rate of rise or a combination of two or more of these or the detection of the absence of one or more of these conditions. In the egress system depicted, central processing unit 14 is electronically connected to a plurality of sensors 12. Central processing unit 14 interprets the signals received from sensors 12 and sends one or more signals conveying the appropriate message to visual signs 10 and lightwave transmitters 22 for real-time conveyance. Preferably, central processing unit 14 conducts a risk assessment after receiving data from sensors 12 in order to determine the optimal egress route. For example, in an emergency egress situation, the computer system will be programmed with appropriate algorithm routines in order to assess the safest route to an exit after assessing all of the detected conditions and alternate route characteristics, for example, route distance, number of turns, elevation changes and such other attributes as may be applicable. A variety of programming may be employed and will depend upon the circumstances in which the system will be instituted. Such programming may be any conventional type, as will be understood by those of ordinary skill in the art.

A feature of this invention is that the visual and non-visual communication is conveyed in real-time. The system is therefore capable of periodically or continually providing current information to both sighted and blind users. This is especially important in an emergency situation in which new hazards can constantly be created and time often becomes critical. For example, as soon as a fire is detected near a particular stairwell, EXIT signs which normally direct users to the stairwell will immediately inform users that the route to the stairwell is no longer a safe means to the exit and direct them to a safer alternate exit.

Another feature of this invention is that the visual and non-visual communication conveyed is situation specific, which allows users to receive information which applies specifically to their location. Situation specific information also allows blind users to receive information without first having to locate certain points of reference. For example, in a hotel, the non-visual communication will guide users directly from their room to the nearest safe exit without the user first having to travel to and locate tactile signs or pushbutton “speak-out” devices which might be found in only a limited number of locations in the building.

Of course, it will be appreciated by one of ordinary skill in the art that the figures are not intended to limit the invention to wired connections between component parts unless so specified.

The disclosure of each patent and patent application referenced above is incorporated herein by reference to the fullest extent as may be permitted by law.

This invention is susceptible to considerable variation in its practice. Therefore, the foregoing description is not intended to limit, and should not be construed as limiting, the invention to the particular exemplifications presented hereinabove. An exemplary, but non-limiting list of claims to the present invention is set forth below.

That which is claimed is:

1. An egress system for use in a structure, which structure defines a plurality of possible paths of travel, said system comprising:
a. one or more visual signs, each of said signs being located at a selected point along one or more of said paths of travel, each of said signs being configured to convey information in the form of visual communication and to convey at least two alternative messages;
b. a central processing unit; and
c. one or more sensors, each sensor being configured to detect an environmental condition and to send a signal indicative of said condition to said processing unit,
wherein said processing unit is configured to determine the safest of said paths of travel based upon signals received from said sensors, and to send a processed signal to each of said signs to thereby cause said signs to convey a pre-selected one of said at least two alternative messages, thereby visually identifying at least one of the safest of said paths of travel under the condition(s) detected.

2. An egress system according to claim 1 further comprising one or more lightwave transmitters, each of said one or more transmitters being embedded within or proximate to one of said signs respectively, each of said one or more transmitters being configured to emit a lightwave signal, said lightwave signal being convertible by a receiver into a signal conveying information which is consistent with the information conveyed through visual communication by said one of said signs.

3. An egress system according to claim 2 wherein said lightwave signal is a frequency modulated lightwave signal.

4. An egress system according to claim 3 wherein said frequency modulated lightwave signal is a frequency modulated infrared signal.

5. An egress system according to claim 2 further comprising at least one loudspeaker embedded within or proximate to one of said signs respectively, said loudspeaker delivering a loudspeaker soundwave signal, said signal conveying information in the form of audible communication which is consistent with the information conveyed through visual communication by said loudspeaker's respective visual sign.

6. An egress system according to claim 5, further comprising said receiver, wherein said receiver is configured to selectively receive said lightwave signal and convert said lightwave signal into intelligible non-visual communication, said receiver being effective only when placed within the range of said lightwave signal.

7. An egress system according to claim 6 wherein said intelligible non-visual communication emanates from an audio or an earphone speaker system.

8. A system according to claim 7 wherein said intelligible non-visual communication is activated by a switch on said receiver.

9. A system according to claim 8 wherein said receiver is portable and comprises a self-contained source of electrical energy.

10. A system according to claim 6 wherein said visual, intelligible non-visual and loudspeaker audible communications are conveyed in real-time.

11. An egress system according to claim 2 wherein said transmitter uses one or more light emitters to send said lightwave signal in the form of one or more encoded speech messages.

12. An egress system according to claim 1 further comprising at least one loudspeaker embedded within or proximate to one of said signs respectively, said loudspeaker delivering a loudspeaker soundwave signal, said signal conveying information in the form of audible communication which is consistent with the information conveyed through visual communication by said loudspeaker's respective visual sign.

13. An egress system according to claim 12 wherein said one of said signs is configured to convey the alternative visual message, EXIT, and is located at the end of said path of travel, and wherein said loudspeaker is configured to repeatedly deliver its soundwave signal.

14. An egress system according to claim 1, wherein said system is further comprised of a plurality of said signs and a plurality of said sensors.

15. An egress system according to claim 14 wherein each of said sensors is capable of detecting a condition selected from the group consisting of temperature, smoke, fire, an activated alarm, obstructions, motion, humidity, temperature rate of rise or a combination of any two or more of the foregoing.

16. An egress system according to claim 1 wherein there are two or more central processing units.

17. An egress system according to claim 16 wherein said more than one central processing units are configured to communicate with one another.

18. A method of providing safe exit from a structure having a plurality of possible paths of travel comprising:
(A) providing one or more sensors for detecting an environmental condition;
(B) sending an electronic signal indicative of said condition to a central processing unit;
(C) configuring said central processing unit to receive said electronic signal, determine the safest path of travel for exiting said structure, and transmit said processed electronic signal to one or more communication devices; and
(D) providing one or more communication devices to receive said processed signal and to convert said processed signal into visual or intelligible non-visual communication, or both.
